(19) United States
(12) Patent Application Publication
(10) Pub. No.: US 2025/0217592 A1
(43) Pub. Date: Jul. 3, 2025

(54) METHOD FOR ON-DEVICE PERSONALISATION OF NLP MODELS

(71) Applicant: SAMSUNG ELECTRONICS CO., LTD., Suwon-si (KR)

(72) Inventors: Umberto MICHIELI, Staines (GB); Mete Ozay, Staines (GB)

(73) Assignee: SAMSUNG ELECTRONICS CO., LTD., Suwon-si (KR)

(21) Appl. No.: 18/403,410

(22) Filed: Jan. 3, 2024

(51) Int. Cl. G06F 40/284

(52) U.S. Cl. CPC G06F 40/284

(57) ABSTRACT

The present techniques generally relate to a computer-implemented method for using continual learning to personalise natural language processing (NLP) models to unseen tasks or domains. The models may be used on various downstream NLP applications, such as Text Classification (TC), Natural Language Inference (NLI), Document or Aspect Sentiment Classification (DSC or ASC). The framework or architecture which may be used as a natural language processing (NLP) model can be trained using continual learning. The framework employs three main modules. The first module is a tokeniser 100 which incorporates a set of adapter modules which allow for adaptation of the model to both new tasks and/or new domains. The second module is a reduction module 106 which uses high order embedding statistics (which may also be termed statistical descriptors) for modeling different characteristics of data from different domains and tasks. The third module is a classifier 108 in the form of a personalized multi-layer perceptron (MLP) head which is for modelling task-specific information and/or domain-specific information.

### CROSS-REFERENCE TO RELATED APPLICATION

This application is based on and claims priority under 35 U.S.C. § 119 to United Kingdom Patent Application No. 2300472.4, filed on Jan. 12, 2023, and United Kingdom Patent Application No. 2305024.8, filled on Apr. 4, 2023, in the United Kingdom Property Office, the disclosures of which are incorporated by reference herein in their entireties.

### BACKGROUND

### 1. Field

The present application generally relates to a method for training machine learning, ML, models so they can quickly adapt to new domains or tasks. In particular, the present application relates to a computer-implemented method for using continual learning to personalise NLP models to unseen tasks or domains.

### 2. Description of Related Art

In continual learning, CL, a machine learning, ML, model learns a sequence of problems incrementally. Continual learning enables Al models to personalise to unseen tasks or domains. For example, an Al model trained on general language domains may be deployed in a specific region with specific proverbial and dialectical expressions, CL allows Al models to adapt to this specific data from the specific region. In another example, users may move between different regions or between different interests, therefore experiencing different domains over time. CL allows Al models to adapt to each of these domains. In both examples, this improves user experience, and enables users to be more engaged with the technology.

However, current CL systems suffer from catastrophic forgetting. That is, when learning multiple problems sequentially, ML models tend to forget the old problems that they have not experienced for a long time. It is also desirable for CL systems to use knowledge transfer, i.e. when learning subsequent problems, ML models can reuse previously acquired knowledge to solve new problems. There is also a challenge in CL to appropriately trade-off between preserving knowledge from the past and learning new problems.

Therefore, the present applicant has recognised the need for improvements in continual learning, particularly when applied to natural language processing, NLP, models.

### SUMMARY

In a first approach of the present techniques, there is provided a computer-implemented method for personalising a machine learning, ML, model, on a user device, the method comprising: obtaining a pre-trained ML model having a set of basic parameters, wherein the pre-trained ML model has been trained to generate a distribution of embedded representations for an input; receiving at least one training set of user data comprising a plurality of training samples, wherein each training set is associated with a particular task or domain; generating, using the pre-trained model, a distribution of embedded representations for each of the plurality of samples; generating multiple statistical descriptors for the distribution of embedded representations, and generating, using the multiple statistical descriptors, an output which is personalised to the user device.

The original training of the machine learning model may have been performed using a labelled training dataset which may have been chosen to be suitable for most users. The set of basic parameters may also be termed the set of original model parameters or the set of original model weights which are learned during the original training. The labelled training dataset may comprise images, audio files, audio clips, videos, and frames of a video depending on the application. For example, an English ASR model is typically trained on American English. However, the user may wish for the machine learning model to be customised/personalised. For example, the user may speak with a different accent which may reduce the accuracy of the English ASR model trained on American English. In order to enable this additional, personalised functionality, the machine learning model needs to be adapted for the user's specific data distribution.

The present techniques enable a machine learning or Al model/algorithm to be customised or personalised in a time-efficient, resource-efficient and cost-effective manner, while also ensuring the model remains accurate. The distribution of embedded representations typically is as large as required for the input which may comprise several data points. For example, for a text input of several words, the distribution will have an embedded representation for each word together with additional representations to indicate structural features, e.g. the start and end of phrases. The statistical descriptors describe the embedded representations using statistics such as statistical moments or other general statistics. The number of statistical descriptors is typically much smaller than the number of embedded representations. For example, there are at least two, and may be three or four statistical descriptors. Preferably there may be three statistical descriptors. The distribution of embedded representations may be output as a feature vector and the statistical descriptors may be output as a concatenated vector. In other words, there are typically fewer statistical descriptors than embedded representations and thus the output statistical descriptors may be considered to be a pooling of the embedded representations. Although there are fewer statistical descriptors than embedded representations, the statistical descriptors preserve most of the information from the limited training samples drawn from non-stationary distributions while preserving previous knowledge. The statistical descriptors help to accurately model the variable distribution of problems (i.e. tasks and/or domains) since input-level distribution shift is reflected into feature-level distribution shift.

In other words, the first approach could be considered to be a computer-implemented method for personalising a machine learning, ML, model, the method comprising: obtaining a pre-trained ML model, trained to perform a particular task; and generating a personalisable version of the pre-trained ML model using high order pooling to enable the pre-trained ML model to move between different tasks and domains.

The multiple statistical descriptors may be generated by a reduction module. The multiple statistical descriptors may comprise statistical moments which are statistics that measure something relative to the center of the values, for example average, variance, skewness and kurtosis. The output multiple statistics may be defined by R=concat(m₁, m₂, . . . , mp), where p is the order of considered moments, m₁ is the first moment (i.e. AVG), m₂ is the second moment (i.e. the variance) and so on. The statistical moments can be calculated using standard approaches and formulae. The statistical moments may be termed high order statistical moments. The statistical moments may be selected in order. For example, if there are two statistical descriptors, these may be the first two statistical moments, e.g. average and variance. Similarly, when there are three statistical descriptors, these may be the first three statistical moments, e.g. average, variance and skewness. The method may comprise computing high-order moments over the distribution of embedded representations to distinguish independent and correlated statistics across different tasks and domains. As well as including statistical moments, the statistical descriptors may comprise other statistics which may be generated using known methods. For example, these other statistics may comprise general statistics which are not measured relative to the centre of the values, for example, co-variance and maximum.

The pre-trained ML model may be a natural language processing ML model. The NLP model could be used for, for example, text classification; Aspect Sentiment Classification (ASC); Document Sentiment Classification (DSC); Text Classification (TC); and Natural Language Understanding (NLU).

For example, the pre-trained model may comprise a tokeniser which extracts embedded representations in the form of tokens from a text input. The tokeniser may generate a token for each data point in a training sample, wherein the data points include individual words and structural features, such as start and end points of a phrase. The tokeniser may generate a classification token as a first token, this may be designated as [CLS]. The classification token may be included in the output multiple statistical descriptors.

The tokeniser may be any pre-trained model, for example a neural network model comprising a plurality of layers, or a transformer comprising an encoder and a decoder each having a plurality of layers. As an example, the pre-trained ML model may be the Bidirectional Encoder Representations from Transformers model which is described in “BERT: Pre-training of Deep Bidirectional Transformers for Language Understanding” by Devlin et al, published in the Conference of the North American Chapter of the Association for Computational Linguistics: Human Language Technologies (NAACL-HLT), 2019.

The method may comprise using a set of adapters to generalize the ML model to unseen problems. The method may comprise adding a plurality of adapter modules (or set of adapter modules) to the pre-trained machine learning model to create a local machine learning model wherein each adapter module has a set of adapter parameters. Each adapter may be considered to be a tunable network which adapts the ML model to an unseen problem.

The set of adapter parameters for the adapter module is typically much smaller than the set of basic parameters. Moreover, changes to the set of basic parameters that were learnt during the original training process are not made or required—this means that the model can be updated quickly as the model does not need to be retrained from scratch. The model can be updated locally, i.e. on the user's device, which means the customisation process uses available resources in an efficient manner and privacy is preserved because the user data does not leave the device.

The pre-trained machine learning model may be a neural network model comprising a plurality of layers. Adding the at least one adapter module may comprise associating an adapter module to at least some of the plurality of layers. For example, an adapter module may be associated with each layer. Associating the at least one adapter module with a layer may comprise adding an adapter module to one or more of the plurality of layers and/or adding an adapter module between a pair of layers in the plurality of layers. An adapter module which is added to a layer may be termed a parallel adapter module. An adapter module which is added between pairs of layers may be termed a serial adapter module. The pre-trained machine learning model may be a neural network model comprising a plurality of transformer building blocks. and adding the at least one adapter module may comprise adding an adapter module to the transformer building blocks, for example after the self-attention layer within the block.

Each one of the plurality of adapter modules may have a single set of adapter parameters which may be represented by a. In other words, the list of adapter modules may be represented by Θ̅{α¹, . . . , α^{L}} where L is the number of layers (or blocks) and there may be one adapter module for each layer (or block). It will also be appreciated that not all layers may have an adapter module. In other words, at least some (and possibly all) layers may be associated with their own adapter module.

Multiple training sets each comprising a plurality of training samples are typically received, particularly for continual learning. Each training set is associated with a particular problem. Personalising the local machine learning model (i.e. pre-trained ML model with adapter module(s)) may comprise using continual learning. Personalising the local machine learning model may comprise selecting a training set; fixing the set of basic parameters; using the selected training set to learn a set of adapter parameters for one adapter module in the plurality of adapter modules; and iterating the selecting, fixing and using for each training set. At each iteration the set of adapter parameters for the other adapter modules are also fixed. There is also no change to the nature of the statistical descriptors which are generated at each iteration.

Thus according to another aspect of the present techniques, there is provided a computer-implemented method for personalising a machine learning, ML, model, on a user device. The method comprises obtaining a pre-trained ML model having a set of basic parameters, wherein the pre-trained ML model has been trained to generate a distribution of embedded representations for an input; receiving multiple training sets each comprising a plurality of training samples, wherein each training set is associated with a particular problem; adding a plurality of adapter modules to the pre-trained machine learning model to create a local machine learning model wherein each adapter module has a set of adapter parameters; and personalising the local machine learning model using continual learning. Personalising comprises selecting a training set; fixing the set of basic parameters; using the selected training set to learn a set of adapter parameters for one adapter module in the plurality of adapter modules and iterating the selecting, fixing and using for each training set. Using the selected training set to learn the adapter parameters comprises: generating, using the pre-trained model, a distribution of embedded representations for each of the plurality of samples in the selected training set; generating multiple statistical descriptors for the distribution of embedded representations, and generating, using the multiple statistical descriptors, an output. There are fewer statistical descriptors than embedded representations.

The output based on the multiple statistical descriptors may be generated in a final (or output) module. The final module may be a classifier for example when the machine learning model is an NLP model and is being used for text classification; Aspect Sentiment Classification; Document Sentiment Classification. When text is input as a training sample, as test sample during the verification process or during inference, the output may be a classification of the text (e.g. as happy, sad, . . . ). The final module may be part of the pre-trained ML model. Alternatively, the final module may comprise a plurality of auxiliary heads which are added to the pre-trained ML model in a similar manner to each of the adapter modules.

Each of the auxiliary heads may be specialised, e.g. for a problem (task or domain). Each auxiliary head may comprise a plurality of auxiliary head parameters. Personalising the local machine learning model (i.e. pre-trained ML model with auxiliary heads) may comprise using continual learning. Personalising the local machine learning model may comprise selecting a training set; using the selected training set to learn a set of auxiliary head parameters for one auxiliary head in the plurality of auxiliary heads; and iterating the selecting and using for each training set. At each iteration the set of auxiliary head parameters for the other auxiliary heads are also fixed. The set of basic parameters may also be fixed in a similar manner to training the adapter modules. When the auxiliary heads and adapter modules are used together, continual learning may be used to personalise the local machine learning model (i.e. pre-trained ML model with adapter modules and auxiliary heads) and at each iteration in the training one set of auxiliary head parameters and one set of adapter parameters may be learnt.

Thus according to another aspect of the present techniques, there is provided a computer-implemented method for personalising a machine learning, ML, model, on a user device. The method comprises obtaining a pre-trained ML model having a set of basic parameters, wherein the pre-trained ML model has been trained to generate a distribution of embedded representations for an input; receiving multiple training sets each comprising a plurality of training samples, wherein each training set is associated with a particular problem; adding a plurality of adapter modules to the pre-trained machine learning model to create a local machine learning model wherein each adapter module has a set of adapter parameters; using a final module to generate the output, wherein the local machine learning model further comprises a plurality of auxiliary heads in the final module, wherein each auxiliary head has a set of auxiliary head parameters and personalising the local machine learning model using continual learning. Personalising comprises selecting a training set; fixing the set of basic parameters; using the selected training set to learn a set of adapter parameters for one adapter module in the plurality of adapter modules and a set of auxiliary head parameters for one auxiliary head in the plurality of auxiliary head parameters and iterating the selecting, fixing and using for each training set. Using the selected training set to learn the adapter parameters comprises: generating, using the pre-trained model, a distribution of embedded representations for each of the plurality of samples in the selected training set; generating multiple statistical descriptors for the distribution of embedded representations, and generating, using the multiple statistical descriptors, an output. There are fewer statistical descriptors than embedded representations.

Using the selected training set to learn the adapter and/or the auxiliary head parameters, may comprise using a loss function which may be any suitable loss function. Learning the parameters may mean selecting the parameters which minimize the loss determined by the loss function. The loss function may be selected from the group comprising an entropy loss function, an infomax loss function, a self-supervised masked prediction function, and a stochastic classifier disagreement loss which minimises a difference between two sampled predictions made by the local machine learning model.

The method may further comprise verifying the personalised (i.e. customized) local machine learning model and/or specialised auxiliary heads after each customisation, e.g. using test data which has been received for each problem. When the customized local machine learning model is not verified, the set of adaptation parameters may be reset to the initial values. In other words, the adapter modules may be disabled. When the customized local machine learning model is verified, the learnt parameters may be stored on the user device and may be used when new samples are received at the user device until the next customization. This verification phase may be useful because for unsupervised on-device adaptation, it is important to ensure that the model continues to work well.

In a related approach of the present techniques, there is provided a computer-implemented method for applying the personalized machine learning model to a new input received by the user device.

In a first related approach, there is provided a method for generating speech based on a text input, the method comprising: receiving, at a first user device, some input text; processing the input text using a ML model which has been personalised on the first user device as described above to classify the input text; outputting the classification of the input text; sending the classification of the input text and the input text to a second user device and outputting, on the second user device, an audio signal in which the input text is spoken with a sentiment corresponding to the classification. As explained above, the first level of personalization is the incorporation of statistical descriptors. Thus, in a related approach, there is provided a method for generating speech based on a text input, the method comprising: receiving, at a first user device, some input text; processing the input text by generating, using a pre-trained model, a distribution of embedded representations for the input text, generating multiple statistical descriptors for the distribution of embedded representations, generating, using the multiple statistical descriptors, an output classification of the input text; outputting the classification of the input text; sending the classification of the input text and the input text to a second user device and outputting, on the second user device, an audio signal in which the input text is spoken with a sentiment corresponding to the classification. Further levels of personalisation of the ML model, e.g. adapters and auxiliary heads may also be incorporated as described above. The ML model may be an ASC model and may comprise a tokeniser and a classifier as described above. Outputting an audio signal may be done using any standard technique.

In a related approach of the present techniques, there is provided a computer-implemented method for generating an image based on a text input, the method comprising: receiving, at a first user device, some input text; processing the input text using a ML model which has been personalised on the first user device as described above to classify the input text; outputting the classification of the input text; generating an image using the classification of the input text and the input text; and outputting the generated image. As explained above, the first level of personalization is the incorporation of statistical descriptors. Thus, in a related approach, there is provided a method for generating an image based on a text input, the method comprising: receiving, at a first user device, some input text; processing the input text by generating, using a pre-trained model, a distribution of embedded representations for the input text, generating multiple statistical descriptors for the distribution of embedded representations, generating, using the multiple statistical descriptors, an output classification of the input text; generating an image using the classification of the input text and the input text; and outputting the generated image. Further levels of personalisation of the ML model, e.g. adapters and auxiliary heads may also be incorporated as described above. As above, the personalised ML model may be an ASC model and may comprise a tokeniser and a classifier as described above. Generating an image may be done using any standard technique.

In a related approach of the present techniques, there is provided a computer-implemented method for outputting an image based on a text input, the method comprising: receiving, at a first user device, some input text; processing the input text using a ML model which has been personalised on the first user device as described above to classify the input text; outputting the classification of the input text; searching for at least one image which matches both the classification of the input text and the input text; and outputting the at least one image which is a match. As explained above, the first level of personalization is the incorporation of statistical descriptors. Thus, in a related approach, there is provided a method for generating an image based on a text input, the method comprising: receiving, at a first user device, some input text; processing the input text by generating, using a pre-trained model, a distribution of embedded representations for the input text, generating multiple statistical descriptors for the distribution of embedded representations, generating, using the multiple statistical descriptors, an output classification of the input text; searching for at least one image which matches both the classification of the input text and the input text; and outputting the at least one image which is a match. Further levels of personalisation of the ML model, e.g. adapters and auxiliary heads may also be incorporated as described above. As above, the personalised ML model may be an ASC model and may comprise a tokeniser and a classifier as described above. The searching may be done using any standard technique.

In a related approach of the present techniques, there is provided a computer-readable storage medium comprising instructions which, when executed by a processor, causes the processor to carry out any of the methods described herein.

As will be appreciated by one skilled in the art, the present techniques may be embodied as a system, method or computer program product. Accordingly, present techniques may take the form of an entirely hardware embodiment, an entirely software embodiment, or an embodiment combining software and hardware aspects.

In a related approach of the present techniques, there is provided a system for customising a machine learning model, the system comprising: a server comprising: a processor for training a machine learning model to learn a set of basic parameters, wherein the pre-trained ML model has been trained to generate a distribution of embedded representations for an input; and an electronic user device comprising: memory for storing the pre-trained machine learning model which is received from the server, and at least one processor coupled to memory. The processor is arranged to: receive at least one training set comprising a plurality of training samples, wherein each training set is associated with a particular problem; generate, using the pre-trained model, a distribution of embedded representations for each of the plurality of samples; generate multiple statistical descriptors from the distribution of embedded representations, and output the multiple statistical descriptors to a final module which produces an output which is personalised to the user device. The multiple statistics moments comprise at least two statistical moments which may be selected from average, variance, skewness, and kurtosis. Further statistics such as co-variance and maximum may be included in the statistical descriptors. Overall, there are fewer statistical descriptors than embedded representations. The processor may be further arranged (or configured) to carry out any of the steps of the method described above.

Furthermore, the present techniques may take the form of a computer program product embodied in a computer readable medium having computer readable program code embodied thereon. The computer readable medium may be a computer readable signal medium or a computer readable storage medium. A computer readable medium may be, for example, but is not limited to, an electronic, magnetic, optical, electromagnetic, infrared, or semiconductor system, apparatus, or device, or any suitable combination of the foregoing.

Computer program code for carrying out operations of the present techniques may be written in any combination of one or more programming languages, including object oriented programming languages and conventional procedural programming languages. Code components may be embodied as procedures, methods or the like, and may comprise sub-components which may take the form of instructions or sequences of instructions at any of the levels of abstraction, from the direct machine instructions of a native instruction set to high-level compiled or interpreted language constructs.

Embodiments of the present techniques also provide a non-transitory data carrier carrying code which, when implemented on a processor, causes the processor to carry out any of the methods described herein.

The techniques further provide processor control code to implement the above-described methods, for example on a general purpose computer system or on a digital signal processor (DSP). The techniques also provide a carrier carrying processor control code to, when running, implement any of the above methods, in particular on a non-transitory data carrier. The code may be provided on a carrier such as a disk, a microprocessor, CD- or DVD-ROM, programmed memory such as non-volatile memory (e.g. Flash) or read-only memory (firmware), or on a data carrier such as an optical or electrical signal carrier. Code (and/or data) to implement embodiments of the techniques described herein may comprise source, object or executable code in a conventional programming language (interpreted or compiled) such as Python, C, or assembly code, code for setting up or controlling an ASIC (Application Specific Integrated Circuit) or FPGA (Field Programmable Gate Array), or code for a hardware description language such as Verilog (RTM) or VHDL (Very high speed integrated circuit Hardware Description Language). As the skilled person will appreciate, such code and/or data may be distributed between a plurality of coupled components in communication with one another. The techniques may comprise a controller which includes a microprocessor, working memory and program memory coupled to one or more of the components of the system.

It will also be clear to one of skill in the art that all or part of a logical method according to embodiments of the present techniques may suitably be embodied in a logic apparatus comprising logic elements to perform the steps of the above-described methods, and that such logic elements may comprise components such as logic gates in, for example a programmable logic array or application-specific integrated circuit. Such a logic arrangement may further be embodied in enabling elements for temporarily or permanently establishing logic structures in such an array or circuit using, for example, a virtual hardware descriptor language, which may be stored and transmitted using fixed or transmittable carrier media.

In an embodiment, the present techniques may be realised in the form of a data carrier having functional data thereon, said functional data comprising functional computer data structures to, when loaded into a computer system or network and operated upon thereby, enable said computer system to perform all the steps of the above-described method.

The methods described above may be wholly or partly performed on an apparatus, i.e. an electronic device, using a machine learning or artificial intelligence model. The model may be processed by an artificial intelligence-dedicated processor designed in a hardware structure specified for artificial intelligence model processing. The artificial intelligence model may be obtained by training. Here, “obtained by training” means that a predefined operation rule or artificial intelligence model configured to perform a desired feature (or purpose) is obtained by training a basic artificial intelligence model with multiple pieces of training data by a training algorithm. The artificial intelligence model may include a plurality of neural network layers. Each of the plurality of neural network layers includes a plurality of weight values and performs neural network computation by computation between a result of computation by a previous layer and the plurality of weight values.

As mentioned above, the present techniques may be implemented using an Al model. A function associated with Al may be performed through the non-volatile memory, the volatile memory, and the processor. The processor may include one or a plurality of processors. At this time, one or a plurality of processors may be a general purpose processor, such as a central processing unit (CPU), an application processor (AP), or the like, a graphics-only processing unit such as a graphics processing unit (GPU), a visual processing unit (VPU), and/or an Al-dedicated processor such as a neural processing unit (NPU). The one or a plurality of processors control the processing of the input data in accordance with a predefined operating rule or artificial intelligence (AI) model stored in the non-volatile memory and the volatile memory. The predefined operating rule or artificial intelligence model is provided through training or learning. Here, being provided through learning means that, by applying a learning algorithm to a plurality of learning data, a predefined operating rule or Al model of a desired characteristic is made. The learning may be performed in a device itself in which Al according to an embodiment is performed, and/or may be implemented through a separate server/system.

The Al model may consist of a plurality of neural network layers. Each layer has a plurality of weight values, and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning algorithm is a method for training a predetermined target device (for example, a robot) using a plurality of learning data to cause, allow, or control the target device to make a determination or prediction. Examples of learning algorithms include, but are not limited to, supervised learning, unsupervised learning, semi-supervised learning, or reinforcement learning.

### BRIEF DESCRIPTION OF THE DRAWINGS

Implementations of the present techniques will now be described, by way of example only, with reference to the accompanying drawings, in which:

FIG. 1 is a schematic diagram of the machine learning framework which is used in the present techniques and which comprises a tokeniser and a reduction module;

FIG. 2a shows a schematic representation of how adapters may be incorporated in a transformer layer of the tokenizer in FIG. 1;

FIG. 2b is a schematic representation of an adapter which may be incorporated in the transformer layer of FIG. 2a;

FIG. 3a is a graph illustrating two examples of high order statistical moments which may be used in the reduction module of FIG. 1;

FIG. 3b is a graph illustrating two examples of high order statistical moments which may be used in the reduction module of FIG. 1;

FIG. 4 is a flowchart of a method of training the framework of FIG. 1;

FIG. 5 is a schematic block diagram of a system incorporating the machine learning framework of FIG. 1;

FIG. 6 is an accuracy matrix showing the main CL metrics used in the experimental works;

FIG. 7 is a table showing two accuracy measures for multiple continual learning methods applied to five benchmark datasets in both TIL and DIL CL setups and using three different architectures;

FIG. 8 is a table showing aggregate results computed from FIG. 7;

FIG. 9 is a table showing a collection of metrics on the DSC small dataset for various prior art approaches and the current method on both TIL and DIL setups;

FIG. 10 is a table showing a combination of the method described herein combined with known continual learning methods on the DSC small dataset;

FIG. 11 is a table showing a collection of metrics on the DSC small dataset for methods which use different pooling schemes and compariing with the method described herein with different values of p;

FIG. 12a plots mAcc_{t≤T} against number of tasks and mAccₜ against number of tasks for a plurality of methods in TIL, including the method described herein;

FIG. 12b plots mAcc_{t≤T} against number of tasks and mAccₜ against number of tasks for a plurality of methods in TIL, including the method described herein;

FIG. 12c plot mAcc_{t≤T} against number of tasks and mAccₜ against number of tasks for a plurality of methods in DIL, including the method described herein;

FIG. 12d plots mAcc_{t≤T} against number of tasks and mAccₜ against number of tasks for a plurality of methods in DIL, including the method described herein;

FIG. 13 is a flowchart of different applications for using the model trained as described in FIG. 4.

FIG. 14 is a flowchart of different applications for using the model trained as described in FIG. 4.

FIG. 15 a flowchart of different applications for using the model trained as described in FIG. 4.

### DETAILED DESCRIPTION

Broadly speaking, the present techniques generally relate to a computer-implemented method for using continual learning to personalise natural language processing (NLP) models to unseen tasks or domains. The models may be used on various downstream NLP applications, such as Text Classification (TC), Natural Language Inference (NLI), Document or Aspect Sentiment Classification (DSC or ASC).

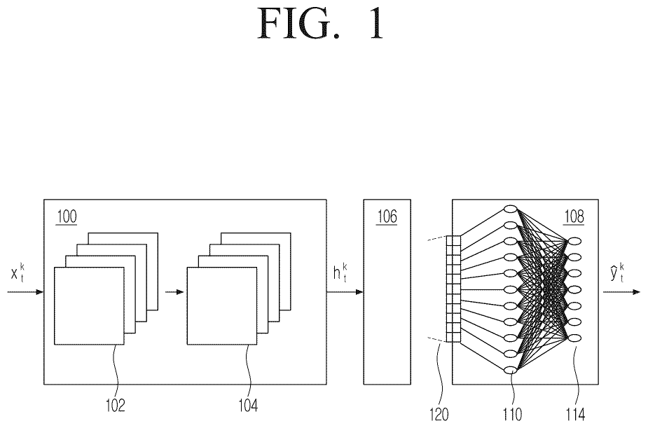

FIG. 1 is a schematic framework or architecture which may be used as a natural language processing (NLP) model which can be trained using continual learning. In continuous learning, a model such as that shown in FIG. 1 learns a sequence of problems incrementally. After each incremental learning stage is completed, its training data is typically discarded. Three main families of continuous learning setups can be identified: namely, Task-Incremental Learning (TIL), Domain-Incremental Learning (DIL), and Class-Incremental Learning (CIL).

Task-Incremental Learning (TIL) builds one model for each task (e.g., to classify sentiment in products' reviews). At test time, a task identifier specifies the proper model for each input sample. TIL may be written as

f:x×C→

[symbol]

where X is the input space, [symbol] is the output space (within context) and C is the context space (more normally referred to the task space in continual learning). Context here refers to the underlying distribution from which observations are sampled. The context typically changes over time. Domain-Incremental Learning (DIL) builds a single head (sub-model) for each domain as classes are shared across domains. In DIL, no identifier is required at test time and subsequent problems present data from different domains (e.g., reviews from online commerce, or from movie critique, etc.). DIL may be written as

f:X→

[symbol]

In Class-Incremental Learning (CIL), non-overlapping classes are learned progressively. CIL progressively learns new classes and it has been less attractive for NLP applications as the number of classes is generally determined a priori. CIL may be written as

f:X→C×

[symbol]

Most of the natural language processing problems are thus formulated as either TIL or DIL (and occasionally as both). The framework shown in FIG. 1 can be used for both Task-Incremental Learning (TIL) and Domain-Incremental Learning (DIL) and as explained in more detail below employs parameter-efficient transfer learning strategies to adapt the models to each end problem.

FIG. 1 shows a new unique framework which addresses three subproblems separately (or together as shown) by employing three main modules. When the three modules are used together, the method may be referred to as HOP because the method “hops” across tasks and domains by addressing the continual learning problem using three modules. The first module is a tokeniser 100 which incorporates a set of adapter modules which allow for adaptation of the model to both new tasks and/or new domains. The second module is a reduction module 106 which uses high order embedding statistics (which may also be termed statistical descriptors) for modeling different characteristics of data from different domains and tasks. The third module is a classifier 108 in the form of a personalized multi-layer perceptron (MLP) head which is for modelling task-specific information and/or domain-specific information.

Problem formulation. Continual Learning (CL) learns a sequence of problems t∈{1, . . . , T}. Each problem t has its test data teₜ and training data trₜ=(Xₜ, [symbol] ₜ), where xₜ^{k}∈Xₜ, k∈{1, . . . , Nₜ} are Nₜ training samples with labels yₜ^{k}∈ [symbol] ₜ (i.e., supervised problems). As shown in FIG. 1, the training samples xₜ^{k} are input to the first module, the tokeniser 100 and the labels yₜ^{k} are the output from the third module, the MLP head 108.

The continual learning goal is to minimize the empirical loss £ over all seen problems. At problem T, we aim at training models fₜ, ∀t, parameterized by θ (i.e., ŷₜ^{k}=fₜ(xₖ^{k}; θ)), which minimize the loss

$${\sum }_{t = 1}^{T} {l}_{t} , with {l}_{t} = \frac{1}{{N}_{t}} {\sum }_{k = 1}^{{N}_{t}} ℒ ( {\hat{y}}_{t}^{k} , {y}_{t}^{k} ) . \qquad ( 1 )$$

where ŷₜ^{k} are the predictions generated by the model, yₜ^{k} are the actual labels, and Nₜ is the number of training samples for each problem t.

In the example of FIG. 1, the function fₜ which maps the input text data to a classification can be considered to be composed of a tokenizer [symbol] and a classifier [symbol] : fₜ= [symbol] ·τ to recognize N_{C} classes. The reduction function performed by the reduction module may be written as [symbol] and this summarizes the whole input sequence into one element. Therefore, we can write τ=R·τ′, with τ′ being the tokenizer without the final reduction function. The overall machine learning model may be expressed as:

$$\hat{y} = 𝒞 \cdot {f}_{w , α}^{L} \cdot … \cdot {f}_{w , α}^{l} \cdot … \cdot {f}_{w , α}^{1} ( x )$$

where ŷ is the output predictions, x is the input, w¹, . . . , w^{L} is the set of weights (or basic parameters), α¹, . . . , α^{L} are the adaptation parameters for each layer l and f_{w,α}^{l} is the function which maps the state of a previous layer x^{l-1} to the state x^{l} of the current layer, and C is the auxiliary classifier MLP head.

Equation (1) typically cannot be minimized because for replay-free CL methods there is no access to previous data (i.e. the labels yₜ^{k}) and for replay CL methods there is limited access to previous data is guaranteed. In the most challenging case of replay-free CL methods, we can minimize the empirical loss on the current problem T only, i.e., l_{T}. Therefore, Continual Learning methods try to approximate Equation (1) in different ways (e.g., via regularization, replay, etc.). In this framework, we extract high-order statistics from the scarce input dataset using the reduction module 106 and we process this additional information via an auxiliary problem-specific MLP head 108 to personalize the current model to the current problem.

The tokeniser 100 may be any suitable tokeniser. For example, the tokeniser may be based on the tokeniser which incorporates adapter modules described in “Parameter-efficient transfer learning for nlp” by Neil Houlsby et al published in Proceeding of the International Conference on Machine Learning (ICML), pages 2790-2799. This approach may be termed Adapter-BERT where BERT stands for Bidirectional Encoder Representations from Transformers and is described in “BERT: Pre-training of Deep Bidirectional Transformers for Language Understanding” by Devlin et al, published in the Conference of the North American Chapter of the Association for Computational Linguistics: Human Language Technologies (NAACL-HLT), 2019.

As shown in FIG. 1, for each problem t, the tokeniser 100 receives an input xₜ^{k} where xₜ^{k}∈Xₜ, k∈{1, . . . , Nₜ} and there are Nₜ training samples in the training data trₜ=(Xₜ, [symbol] ₜ). For example, in the context of natural language processing, the input may be phrases such as “my input is a sentence” and “the sentence is long”. Each phrase is separated into data points corresponding to the individual words, a special classification token [CLS] which is always the first token and a separator token [September] which indicates the separation between the sentences. The tokeniser 100 generates a plurality of tokens hₜ^{k}∈Hₜ, k∈{1, . . . , Nₜ}; one token embedding for each data point. BERT also generates segment embeddings for each segment and position embeddings. Examples are given in the table below:

| Input | [CLS] | [my] | [input] | [is] | [a] | [sentence] | [SEP] | the |
|---|---|---|---|---|---|---|---|---|
| Token | h_{[CLS]} | h_{[my]} | h_{[input]} | h_{[is]} | h_{[a]} | h_{[sentence]} | h_{[SEP]} | h_{[the]} |
| Embedding | | | | | | | | |
| Segment | h_{A} | h_{A} | h_{A} | h_{A} | h_{A} | h_{A} | h_{A} | h_{B} |
| Embedding | | | | | | | | |
| Position | h₀ | h₁ | h₂ | h₃ | h₄ | h₅ | h₆ | h₇ |
| Embedding | | | | | | | | |

The standard BERT model architecture is a multi-layer bidirectional transformer encoder based on the original implementation described in “Attention is all you need” by Vaswani et al published in in the Conference on Neural Information Processing Systems (NIPS), 2017. This is schematically represented in FIG. 1 which shows that the tokenizer 100 comprises a multi-layer encoder 102 and a multi-layer encoder 104. There may be the same number of layers, e.g. six as described in the paper above, in each of the encoder and the decoder.

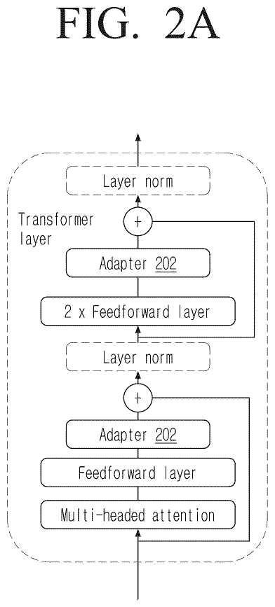

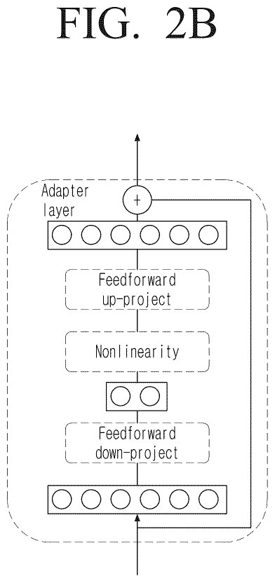

The framework relies on Adapter-BERT, which has a separate set of adapters tuned for each problem. One example of how these adapter modules can be incorporated in a transformer layer (or transformer block, the terms may be used interchangeably) is shown in FIG. 2a. FIG. 2a shows the various sub-layers of a transformer layer, e.g. the multi-headed attention layer, the feed-forward layers and the layer normalization parameters. There are two adapter modules 202 which have been incorporated in the transformer layer. In this example, a first adapter module has been added after the feed-forward layer which follows the multi-headed attention layer. A second adapter module is added after the other two feed-forward layers. Each transformer block may be expressed as a model fₜ, ∀t and may be parameterized by θ (i.e., ŷₜ^{k}=fₜ(xₜ^{k}; θ)).

FIG. 2b illustrates an example of an adapter module which may be incorporated in the transformer layer. The adapter module comprises a bottleneck indicated by the layer with a smaller number of circles than the input and output sub-layers. The bottleneck contains fewer parameters relative to the attention and feedforward sub-layers in the transformer module. The adapter also comprises a skip module. By adding an adapter module, we define a new model which has a set of adapter parameters a and the set of new parameters is much smaller than the original parameters θ. The new model is thus defined as ŷ=fₜ(xₜ^{k}; θ, α). During training, only the adapter parameters α for the current task t are being trained. In other words, only the adapter module for that current task is trained. This means that only the sub-layers indicated with dashed lines, i.e. the layer normalization parameters in FIG. 2a and the various layers in FIG. 2b are trained. The other layers are fixed or frozen. Here we observe the modular property of the proposed method, so it can be plugged on top of other continual learning methods. Compared to existing methods, HOP only brings a minimal computation and complexity footprint.

Adding adapters to BERT is a highly parameter-efficient transfer learning paradigm. In continual learning, this means that subsequent problems have separate adapters (which are small in size) to transfer the knowledge and adapt the pre-trained BERT model to each end problem. The adapter layer may be a tunable 2-layer fully-connected network. By using adapter modules, there is no need for a separate BERT model fine-tuned on each problem, which is extremely parameter-inefficient if many problems are learned in sequence.

Pooling in NLP has been recently studied to improve accuracy. Pooling layers plays a critical role in the size and complexity of the model. An example of pooling is described in “Attentive pooling with learnable norms for text representation” by Wu et al published in Annual meeting of the Association for Computation Linguistics (ACL) in 2020. This proposes an attentive pooling scheme with learnable norm to extract accurate text representations in different problems, motivated by three observations. In a first observation, different contexts have different informativeness for learning text representations (e.g. the input “but” might be important to determine sentiment polarity, but is probably less relevant for text classification). In a second observation, different problems have different characteristics and in a third observation, popular pooling methods (such as MAX or AVG) may over-emphasize some concepts and disregard other useful contextual information. To summarize, some words or sentences, which may be problem-dependent, contain information regarding output class in various ways. Typically, such pooling schemes cannot be applied to continual learning.

Returning to FIG. 1, the second module is a reduction module 106 which processes multiple statistical descriptors which include multiple statistical moments and optionally other statistics from the encoded text to capture overall evolution of the input. The reduction module 106 computes statistical descriptors from the distribution of extracted tokens hₜ^{k} to acquire most of the information from the input sequence. We compute statistical descriptors from the input sequence and concatenate the resulting processed tokens. We define the reduction function by

[symbol]

=concat(m₁,m₂, . . . ,mₚ) (2)

where p is the order of considered statistical moments, m₁ is the first moment (i.e. AVG), m₂ is the second moment (i.e. the variance) and so on. Such moments are computed over the distribution of tokens identified by the unreduced tokenizer [symbol] ′:xₜ^{k}→k_{t,d}^{k} where d denotes the dimensionality of the embedded sequence and each h_{t,d}^{k}∈ [symbol] ^{s}, where S is the channel size. It will be appreciated that although the concatenated vector above only includes statistical moments, the vector could be expanded to include other statistics and optionally the [CLS] token.

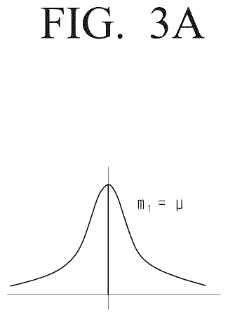

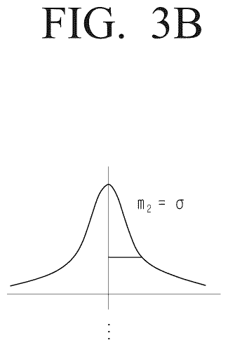

FIGS. 3a and 3b illustrate two statistical moments. FIG. 3a illustrates the average μ and FIG. 3b illustrates the variance σ. As shown, moments in statistics typically measure something relative to the center of the values. The statistical moments can be calculated using standard approaches and formulae and typically include average, variance, skewness and kurtosis. The moments are normally ordered with average being the first moment and kurtosis being the fourth moment. For example, a method of calculating the average is described in “Gradient-based learning applied to document recognition” by LeCun et al published in Proceedings of the IEEE in 1998. Moreover it will be appreciated that these are just two examples and other moments may be calculated.

Other statistics may be included in the statistical descriptors for example maximum (e.g. as calculated in “Hierarchical models of object recognition in cortex” by Riesenhuber et al published in Nature Neural Networks in 1999), standard deviation (e.g. as calculated in “Revisiting the statistics pooling layer in deep speaker embedding learning” published by Wang et al in IEEE International Conference on Big data in 2021) or covariance (e.g. as calculated in “Towards faster training of global covariance pooling networks by iterative matrix square root normalization” by Li et al published in Conference on Computer Vision and Pattern Recognition in 2018).

There may be two, three or four statistical descriptors, more preferably three. When three moments are selected, the first three moments are selected, e.g. average, variance and skewness. Similarly, when two moments are selected, they are typically the first two, namely average and variance. The first statistical descriptor may be the [CLS] token.

By contrast, existing approaches design their continual learning systems so that R is often identified by the [CLS] token or by AVG pooling. We have recognised that different problems usually have different peculiar patterns in the input samples and the output should be an explicit function of the whole, non-reduced, embedding sequence. This method of pooling may be termed high-order pooling.

Returning to FIG. 1, the third and final module is a classifier 108 which processes and combines the embeddings computed by the tokeniser τ as concatenated from the reduction function 106. The concatenated vector 120 is input to an auxiliary MLP head specialized for each problem. The MLP head increases the personalization capacity to process the high order information while being highly parameter efficient. In this example, the MLP head comprises an input layer 110 and an output layer 114. For example the input layer may comprise a number of neurons equal to the number of moments multiplied by the channel size (i.e. p·S) and the output layer may comprise N_{c} neurons, where C represents the number of classifications. More than two layers may be used but this will increase complexity and as illustrated below the results are good with just the two layers. It is noted that the classifier in a typical natural language processing framework is a linear layer.

Overall, the method described above can extract richer information from the limited samples drawn from the non-stationary input sequence distributions while preserving previous knowledge. The method can hop across the distributions of subsequent tasks and domains, since input-level distribution shift is reflected into a feature-level distribution shift via the embedding tokenizer. The method may thus be known as HOP. Our framework is applicable to both TIL and DIL setups.

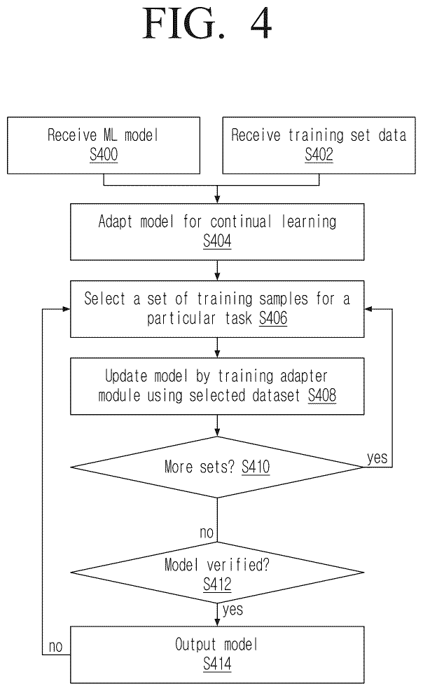

FIG. 4 is a flowchart of the training method described above. In a first step S400, a machine learning model is received. The received model may have been pre-trained, e.g. on a server. In a next step S402, training set data is received. The training set data comprises a plurality of training samples for multiple tasks. At step S404, the received model may optionally be adapted for continual learning. For example, the adapter modules and/or the auxiliary heads for each task may be added.

At step S406, a set of training samples which relate to a particular task are selected. At step S408, the received model is updated using the selected set of training samples. In this step, only the parameters of a single adapter module and/or a single auxiliary head are trained. The trained adapter module and/or trained auxiliary head is thus associated with the particular task. During the training process, the tokeniser creates the tokens, the statistical descriptors for the tokens are generated as described above and the statistical descriptors are used to generate an output. There is then a decision at step S410 to determine if there are more set of training data. If there are more sets, the method loops back to step S406.

Otherwise, the method proceeds to the verification of the model using the test data. There is a decision as to whether the model is verified at step S412. If the model is verified, the model is output at step S414. Otherwise, the method loops back to step S406, to retrain the model.

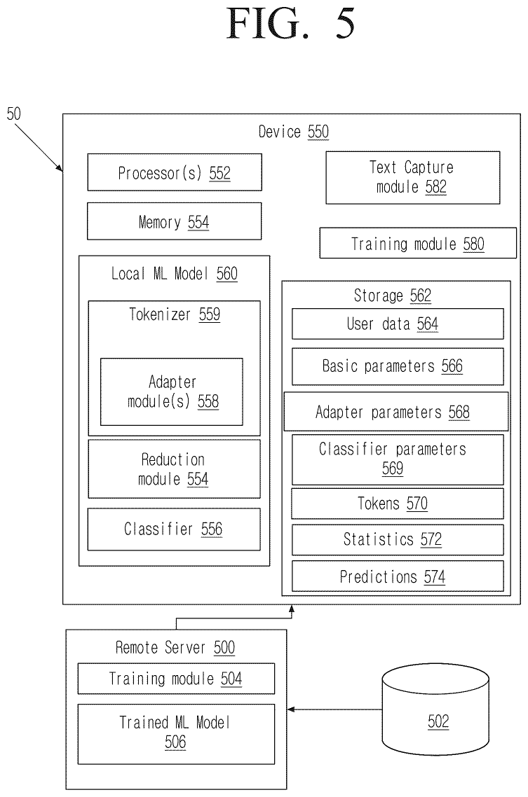

FIG. 5 is a block diagram of a system 50 comprising a server 500 for training a machine learning, ML, model and a device 550 for implementing the methods described above to update the ML model stored on the local device.

The server 500 is arranged to perform any pre-training steps which are required to generate an initial trained ML model 506. The server 500 receives reference training data (inputs x and labels y) from a database 502. The server 500 comprises a training module 504 which receives as input the reference data from the database 502 and outputs the basic model parameters (i.e. the set of weights or parameters θ which have been learnt during the training process).

The device 550 may be any one of: a smartphone, tablet, laptop, computer or computing device, virtual assistant device, a vehicle, a drone, an autonomous vehicle, a robot or robotic device, a robotic assistant, image capture system or device, an augmented reality system or device, a virtual reality system or device, a gaming system, an Internet of Things device, or a smart consumer device (such as a smart fridge). It will be understood that this is a non-exhaustive and non-limiting list of example apparatus. The device 550 comprises the standard components, for example at least one processor 552 coupled to memory 554. It will be appreciated that there may be other standard components which are not shown for simplicity.

The server 500 is communicatively coupled to the device 550 and is able to transmit the trained ML model and its basic parameters to the device 550. As explained above, the trained ML model may comprise a tokenizer 560 with one or more adapter modules 558, a reduction module 554 and a classifier 556. Together these create a local ML model 560. The local ML model may be termed a personalized ML model 560 and may be specific to the device 550. The basic parameters 560 of the trained ML model are stored or (cached) in storage 562 which is on the device.

The number of basic parameters will depend on the model. For example, BERT has 340 million parameters. Other well known models such as GPT-2 or Chat-GPT have 1.5 billion or 20 billion parameters respectively.

The device 550 may comprise one or more modules for collecting user data 564 which is also stored in storage 562. Merely as examples, the modules may include a text capture module 582 for capturing user data in the text input which are to be processed by the local ML model 560.

The inputs to the local ML model 560 include the user data 564, the basic model parameters 566, the adapter parameters 568 and the classifier parameters 569 which are the parameters of the auxiliary heads. During the training process, the initial adapter parameters may be zero. Similarly, the initial parameters of the auxiliary heads may be zero. The output from the local ML model 560 is the predicted labels y which are stored in storage 562 as predictions 570. The predictions 570 may be used together with the user data 564 to update the local ML model 560 as described above. The predictions 570 and user data 564 are thus inputs to the local training module 580. Each update to the local ML model generates adapter parameters 566 which are stored in the local storage 562. The device then uses the stored adapter parameters 566 when the local ML model 560 is updated to include them. When using the local ML model 560, the tokenizer 559 generates tokens 570 which may be stored in the local storage 562. Similarly, the reduction module 554 generates statistics 572 (which may also be termed statistical descriptors) which may be stored in the local storage 562.

The at least one processor 552 may comprise one or more of: a microprocessor, a microcontroller, and an integrated circuit. The memory 554 may comprise volatile memory, such as random access memory (RAM), for use as temporary memory, and/or non-volatile memory such as Flash, read only memory (ROM), or electrically erasable programmable ROM (EEPROM), for storing data, programs, or instructions, for example.

### Experiments

Architectures. FIG. 1 shows the complete architecture for the method described above which includes the high-order pooling steps. As explained above, the architecture is developed from BERT. Previous works have suggested fine-tuning BERT. Fine-tuning such a large pre-trained model reaches state-of-the-art results on NLP benchmarks with a static distribution. However, if a stream of problems are presented sequentially, there are two potential problems. The first is catastrophic forgetting (CF) of previous knowledge due to the non-stationary data distribution. The second is that fine tuning cannot make use of past knowledge to improve capability on subsequent problems (forward knowledge transfer KT) or vice-versa (backward knowledge transfer KT).

High catastrophic forgetting and low knowledge transfer hinder performance in continual learning for natural language processing (NLP), as several NLP applications share similar knowledge that can be exploited to achieve higher accuracy on future/previous problems, without accuracy degradation on previous problems. Indeed, ideally, learning a sequence of problems should allow multiple problems to support each other via knowledge transfer.

Previous works have shown that naïvely fine-tuning BERT increases catastrophic forgetting, and thus we focus on the following architectures to test the performance of the proposed method. A first architecture comprises a frozen BERT with a trainable text classifier in the form of a linear layer and may be termed BERT (Frozen)+Linear. A second architecture comprises a frozen BERT with a trainable text classifier in the form of a convolutional neural network (CNN) and may be termed BERT (Frozen)+CNN. The third architecture is the tokeniser of FIG. 1 which trains only the adapter blocks built of 2 linear layers with 2000 neurons each and may be termed Adapter-BERT.

Baselines. For each of the three architectures, there are baselines used for the comparison. As the first baseline, we consider a separate model learned for each problem independently, which we call SDL (standalone) variant. This has no knowledge transfer or catastrophic forgetting. Second, we compare against fine-tuning (FT) which simply optimizes the model over the sequence of problems. Each of the three architectures is also shown with the HOP system (i.e. the complete system shown in FIG. 1).

For the second and third architectures, we also consider thirteen known continual learning methods. Among them, some approaches have been proposed for continual learning in NLP and additionally, we adapted continual learning methods from the image classification domain. These methods include regularization-based approaches such as EWC, OWM, and L2. EWC and L2 are described in “Overcoming catastrophic forgetting in neural networks” by Kirkpatrick et al published in Proceedings of the National Academy of Sciences in 2017. OWM is described in “Continual learning of context-dependent processing in neural networks” by Zeng et al published in Nature Machine Intelligence in 2019. These methods also comprise replay-based methods such as A-GEM which is an efficient version of GEM, and DER++ for pseudo replay. A-GEM is described in “Efficient lifelong with A-GEM” by Chaudhury et al published in International Conference on Learning Representations in 2018. DER++ is described in “Dark experience for general continual learning: a strong, simple baseline” by Buzzega et al published in “Advances in Neural Information Processing Systems in 2020.

As task incremental learning based works, the following methods are considered: UCL which proposes uncertainty-regularized CL based on a Bayesian online learning framework and HAT which focuses on problem embeddings protecting information of previous problems while learning new ones. UCL is described in “Uncertainty-based continual learning with adaptive regularization” by Ahn et al published in the Neural Information Processing Conference in 2019. HAT is described in “Overcoming catastrophic forgetting with hard attention to the task” by Serra et al published in the International Conference on Machine Learning in 2018.

For the BERT frozen+CNN architecture, CAT, SRK and KAN are also used. SRK and KAN tackled DSC via recurrent architectures. They are mainly conceived for knowledge transfer, hence they suffer from catastrophic forgetting and cannot be easily extended to BERT. CAT works on a mixed sequence of similar and dissimilar problems and can transfer knowledge among similar problems. CAT is described in “Achieving forgetting prevention and knowledge transfer in continual learning” by Ke et al published in Advances in Neural Information Processings Systems in 2020. SRK is described in “Sentiment classification by leveraging the shared knowledge from a sequence of domains” by Lv et al published in International Conference on Database Systems for Advanced Applications in 2019. KAN is described in “Continual learning with knowledge transfer for sentiment classification” by Ke et al published in Joint European Conference on Machine Learning and Knowledge Discovery in Databases in 2020.

For the BERT frozen+CCN architecture, CAT, SRK and KAN are not used because they cannot work with adapters but B-CL, CTR and CLASSIC are used instead. B-CL is the first continual learning framework for aspect sentiment classification (ASC). It employs Adapter-BERT and is based on capsule network and dynamic routing, bringing only limited knowledge transfer. CTR extends the adapters concept to the idea of CL plugins to adapt BERT to each problem, and it is the state of the art in TIL. CLASSIC uses contrastive learning to promote knowledge transfer and is proposed for ASC, where it is currently the state of the art. B-CL is described in “Adapting BERT for continual learning of a sequence of aspect sentiment classification tasks” by Ke et al published in Conference of the North American Chapter of the Association for Computational Linguistics: Human Language Technologies” in 2021. CTR and CLASSIC are described in “CLASSIC: Continual and Contrastive Learning of Aspect Sentiment Classification Tasks” by Ke et al published in Conference on Empirical Methods in Natural Language Processing in 2021. We note that B-CL, CTR and CLASSIC cannot work with the CNN head and thus are not included in the evaluation on the second architecture.

It is noted that unlike traditional continual learning approaches used in computer vision, most of the NLP problems are formulated as either task-incremental learning (TIL) or domain-incremental learning (DIL) and are not normally tackled together. For example, the methods UCL, HAT, CAT, CTR, KAN, B-CL and SRK are TIL and the LAMOL and CLASSIC are DIL. CTR, KAN, B-CL, LAMOL, CLASSIC and SRK are originally proposed in NLP. The CLASSIC method may also have reduced evaluation of the method in TIL. The current state-of-the-art approach in TIL is normally considered to be CTR and the current state-of-the-art approach in DIL is CLASSIC. For the sake of clarity, we refer to problems as either tasks or domains experienced by the CL method over time.

Datasets. We consider four applications of the ML models, unifying previous works. The first application is aspect sentiment classification (ASC) which classifies a review sentence on either positive, negative or neutral aspect-level sentiments. We use 19 datasets (i.e. reviews of 19 products) taken from four sources: 5 products from HL5Domains, as described in: “Mining and summarizing customer reviews.” by Minqing Hu and Bing Liu published in ACM SIGKDD International Conference on Knowledge Discovery and Data Mining, pages 168-177 in 2004; 3 products from Liu3Domains, as described in: “Automated rule selection for aspect extraction in opinion mining” by Liu et al published in International Joint Conference on Artificial Intelligence (IJCAI) in 2015; 9 products from Ding9Domains, as described in: “A holistic lexicon-based approach to opinion mining” by Ding et al published in International Conference on Web Search and Data Mining, pages 231-240 in 2008; and 2 products from SemEval14 Task 4, as described in: “SemEval-2014 task 4: Aspect based sentiment analysis” by Pontiki et al published in PInternational Workshop on Semantic Evaluation (SemEval 2014), pages 27-35, Dublin, Ireland. Association for Computational Linguistics in 2014. We applied the same data filtering of previous works such as described in: “Achieving forgetting prevention and knowledge transfer in continual learning” by Ke et al published in Advances in Neural Information Processing Systems (NeurIPS), 34:22443-22456 in 2021, and as described in: “CLASSIC: Continual and Contrastive Learning of Aspect Sentiment Classification Tasks” by Ke et al published in Conference on Empirical Methods in Natural Language Processing (EMNLP), pages 6871-6883 in 2021 for fair comparison. The second application is document sentiment classification (DSC) which classifies product reviews into either positive or negative opinion classes, using text classification formulation of BERT. We use 10 DSC datasets (i.e. reviews of 10 products) taken from: “Continual learning with knowledge transfer for sentiment classification” by Ke et al published in Joint European Conference on Machine Learning and Knowledge Discovery in Databases, pages 683-698. Springer in 2020. We consider both a small training version of 100 positive and 100 negative reviews per problem, and the full training version of 2500 positive and 2500 negative reviews per problem. Validation and test sets are fixed and consist of 250 reviews per each class. The first experiment is arguably more useful in practice because labeling a large number of examples is costly, therefore, ablation is carried out on this split.

The third application is text classification and classifies text into 20 classes using 20News data taken from: “Newsweeder: Learning to filter netnews” by Lang published in Machine Learning Proceedings, pages 331-339. Elsevier in 1995. We divided documents into 10 problems with 2 classes per problem (in DIL, Nc is supposed known a priori). Classes are variegate and share little knowledge, hence here we show how forgetting is reduced. The fourth application targets natural language inference (NLI) for sentence understanding using the MultiNLI dataset, one of the largest corpus of its kind and described in: “A broad-coverage challenge corpus for sentence understanding through inference” by Williams et al published in Conference of the North American Chapter of the Association for Computational Linguistics: Human Language Technologies. Association for Computational Linguistics in 2018. Sentences are classified into 3 classes: entailment, neutral and contradiction. We split data in 5 problems, each belonging to a specific domain (fiction, telephone, etc) as described in: “Progressive memory banks for incremental domain adaptation” by Asghar et al published in International Conference on Learning Representations (ICLR) in 2020.

Hyperparameters. We employ the same scenarios as current state-of-the-art approaches. We follow the continual learning evaluation of “A continual learning survey: Defying forgetting in classification tasks” by De Lange et al published in IEEE Transactions on Pattern Analysis and Machine Intelligence (TPAMI), in 2021. That is, after training on one problem is completed, the respective training data is no longer accessible. All hyperparameters are chosen according to the performance on the validation set and after all problems are learned, testing is carried out on the test set. We report results averaged over five orderings of problem sequences and we report the mean since the standard deviation is negligible (lower than 0.1 in all cases). All the baseline approaches consider the embedding of the [CLS] token as the output. We show that this is a major limitation and have proposed a simple and effective framework to overcome it. The only hyperparameter specific to our framework is the number of statistical descriptors (e.g. moments) which are considered, namely p. This is set according to the best validation performance from a grid search. Empirically, p=3 provides the best results and represents a good compromise with additional computational complexity.

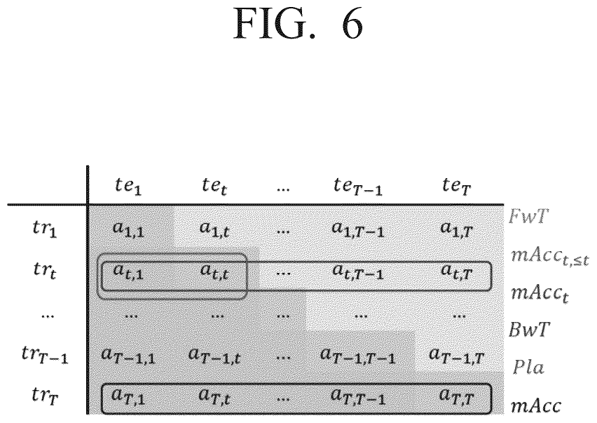

Metrics. FIG. 6 illustrates the accuracy matrix which is created using teₜ and trₜ which are the testing and training datasets at step t. To fully characterize the different approaches, we report a wide range of forgetting and transfer metrics which are calculated using the accuracy matrix as shown in FIG. 6. We compute both mean accuracy (mAcc, ↑) and macro-F1 (MF1, ↑), to reduce biases in accuracy originating from imbalanced classes. The different mean accuracies are calculated as follows:

$$m A c c = \frac{1}{T} {\sum }_{j = 1}^{j = T} {a}_{T , j}$$

$$mAc {c}_{t} = \frac{1}{T} {\sum }_{j = 1}^{j = T} {a}_{t , j}$$

$$mAc {c}_{t , \leq T} = \frac{1}{t} {\sum }_{j = 1}^{j = t} {a}_{t , j}$$

The three different means track different aspects. For example, Classical mean accuracy is calculated at the end of training and averages over all the problems. The second mean accuracy in the list above is calculated at step t, and is the mean accuracy averaged over all the problems (also unseen problems). The second mean accuracy in the list above is calculated at step t and is the mean accuracy averaged over all previous problems (no unseen problems). Macro-F1 score is a classical metric and may be calculated as described in “Micro, Macro & Weighted Averages of F1 Score, Clearly Explained” by Kenneth Leung published in Towards Data Science in 2022.

Backward transfer (BwT, ↑) tracks the influence that learning a new problem has on the preceding problems' performance, to measure stability. This is calculated using all the accuracy measures on the bottom left of the matrix, i.e. using all a_{i,j}∀i, j which satisfy t≤i≤T, 1≤j≤T−1, where T is the total number of tasks. Forward transfer (FwT, ↑) measures the positive influence of learning a problem on future problems' performance. This is calculated using all the accuracy measures on the top right of the matrix, i.e. using all a_{i,j}∀i, j which satisfy 1≤i≤T−1, t≤j≤T, where T is the total number of tasks. Forgetting (Forg, ↓) averages the difference of class-wise accuracy achieved at the last step and the best class-wise accuracy achieved previously. Plasticity (Pla, ↑) averages the accuracy achieved on each problem evaluated right after learning that problem. Plasticity is thus calculated from:

$$Pla = \frac{1}{T} {\sum }_{k = 1}^{k = T} {a}_{k , k}$$

Additionally, we report (in millions) the number of overall parameters (#OP, ↓), the number of trainable parameters (#TP, ↓), and the computation time (↑, in minutes) evaluated on the task incremental learning setup, which is the worst case for our framework.

### EXPERIMENTAL RESULTS

Main Results. As explained above, the results show the evaluation on five benchmark datasets (ASC, DSC small, DSC full, 20News, NLI) targeting four applications (ASC, DSC, TC, NLI) in 2 continual learning setups (DIL and TIL) and 3 network architectures based on BERT. In each of the tables, the best result is shown in bold.

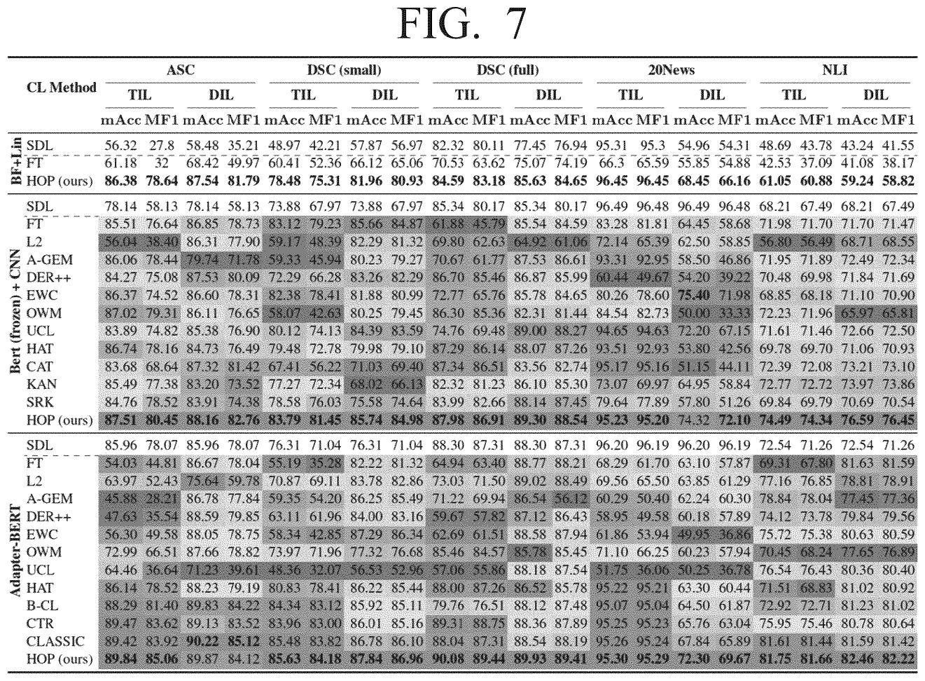

FIG. 7 shows that HOP (which as described above is the whole system shown in FIG. 1) results in a performance which clearly outperforms or achieves comparable results to baseline methods in every scenario. We observe that mAcc and MF1 generally show consensus in identifying the best methods. Also, results are higher in the DIL setup since a single head can transfer knowledge more easily.

In the first block of results shown in FIG. 7, we evaluate on the first architecture which is frozen BERT with a trainable linear head (BF+Lin). Due to the low accuracy of this architecture, we compare our framework only against the standalone variant (SDL) and the fine-tuning variant (FT). HOP outperforms both by a large margin in every case.

In the second block of results shown in FIG. 7, we evaluate on the second architecture which is frozen BERT with a trainable CNN head. Here, we report comparison against several approaches as explained above. HOP outperforms all other methods in almost every case.

Finally, the best results are achieved in the third block of results shown in FIG. 7 in which the methods are evaluated on the third architecture which is Adapter-BERT. This architecture is closest to the architecture described in FIG. 1. HOP outperforms all other methods in most cases.

It is also noted that the SDL baseline outperforms some of the prior art approaches, due to increased capacity to personalize to the end problem. However, the SDL baseline builds a model for each problem independently using a separate network, therefore, it does not handle catastrophic forgetting or knowledge transfer. On the other hand: fine-tuning, and regularization-based approaches (such as EWC, OWM, and L2) and replay-based approaches (such as A-GEM and DER++) are generally better in the second architecture BERT (Frozen)+CNN than in the third architecture Adapter-BERT, due to the reduced number of parameters to update and apply regularization on. KAN and HAT require problem identity and suffer from catastrophic forgetting in the TIL setup. We extended them to DIL by using the third architecture, which however shows low results in DIL. Similarly, also CAT (which extends HAT), SRK and UCL cannot achieve competitive results. Approaches specifically designed for CL in NLP (i.e., B-CL, CTR, and CLASSIC) show clear improvements compared to the others. B-CL and CTR have been mainly designed for TIL: they achieve competitive results in TIL setup, however they fail when employed in DIL. CLASSIC has been specifically designed for DIL: it achieves competitive results on TIL and can improve on DIL compared to other approaches.

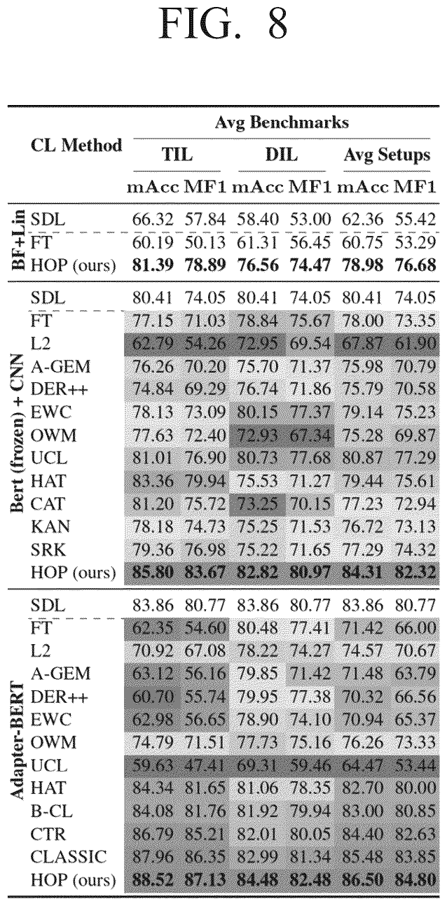

FIG. 8 is a table showing the aggregate results from the detailed analysis shown in FIG. 7. The first two columns average over the five benchmarks for TIL, the next two columns averaged over the five benchmarks for DIL and the last two columns average over both benchmarks and CL setups. The results show that HOP robustly outperforms all the baseline known methods in both TIL and DIL (first and second vertical groups). Finally, the last vertical block provides a further comparison aggregated across all benchmarks and CL setups which is useful to gain a sense of the overall results. Overall, the best performing frameworks are HOP, UCL and HAT for BERT (Frozen)+CNN, and HOP, CLASSIC, CTR, B-CL, HAT for Adapter-BERT. It is also noted that class-incremental learning based methods are inadequate for TIL and DIL in NLP. In summary, our framework HOP outperforms or is comparable to current state-of-the-art baseline known methods in every evaluated scenario and it can deal both with large scale data (e.g. in DSC full) and with limited data (e.g. in DSC small) in both TIL and DIL. As expected, the gain of HOP is less marked when more data is available (DSC full versus DSC small), because when data is abundant, extracting high order information gives fewer extra clues.

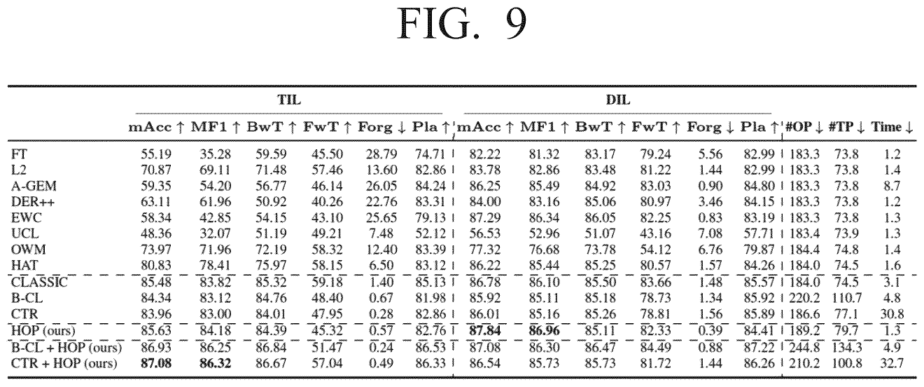

Catastrophic Forgetting and Knowledge Transfer. FIG. 9 reports additional metrics to evaluate the intrinsic CF and KT properties of CL models for both TIL and DIL in the DSC small dataset. Again, we remark that the highest gains are found in the TIL setup. Most regularization- and replay-based approaches designed for image classification (first group of eight rows) are inadequate to address CL in NLP. These methods show low accuracy due to high forgetting and low transfer, despite having good plasticity (Pla) to learn a new problem. Methods designed for CL in NLP (second group of three rows), instead, can effectively increase accuracy (mAcc and MF1) by increasing KT (BwT and FwT), reducing Forg whilst maintaining Pla. Compared to the prior art, our proposed method HOP can find a better balance between CF and KT. In both TIL and DIL, modeling higher order statistics using HOP leads to increase mAcc and MF1 by reducing Forg, although showing comparable or more conservative results in terms of KT properties (BwT, FwT and Pla of HOP are not always maximized). Overall, our framework achieves a better trade-off and outperforms methods proposed specifically for TIL (i.e, CTR and B-CL) and for DIL (i.e, CLASSIC).

In the last two rows of FIG. 9, HOP is combined with the best known methods from the previous results and this further boosts their metrics. The integrated methods robustly outperform the original methods along all the evaluated metrics.

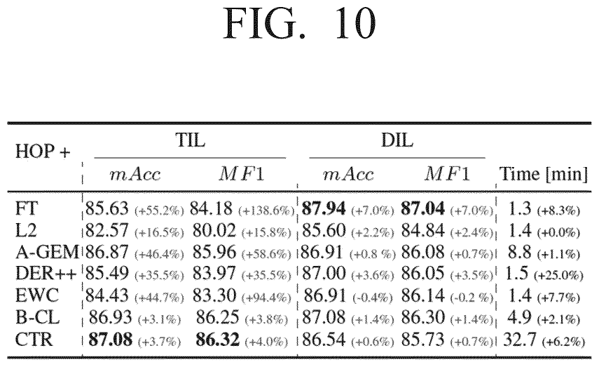

HOP improves other CL methods. To ensure that HOP is beneficial to continual learning (CL) in NLP applications, we include it in known continual learning methods (FT, L2, A-GEM, DER++, EWC, B-CL, CTR) and report the results in FIG. 10 for DSC small in both TIL and DIL setups. FIG. 10 also shown in brackets the gains when compared with the results of the single methods in FIG. 7. FIG. 10 shows clearly that combining HOP with a known method improves the method almost every time, with the only exception being for EWC DIL. In some cases, we observe a large gain up to about 140%. The gain is experienced in both TIL and DIL, the former being more largely improved by our HOP. Remarkably, also current state-of-the-art approaches as B-CL and CTR are significantly improved by our framework.

Efficiency. On the other hand, HOP only adds a small increase in computation parameters and time, both when used alone or in combination with other approaches. We show these results in the last three columns of FIG. 9 and in the last column of FIG. 10. First, from FIG. 9, we observe that adapters account only for 40% (73.8M) of the total number of parameters (183.3M), while clearly outperforming architectures with only a linear or convolution-based trainable head. Compared to FT, HOP introduces just about 3% more total parameters, increasing the average running training time per problem by about 8% (1.2 to 1.3 min). Second, we confirm in FIG. 10 that HOP only adds a minimal increase in computation time when added on top of existing CL methods. On average, HOP increases the mean running time per problem by just 7.2%.

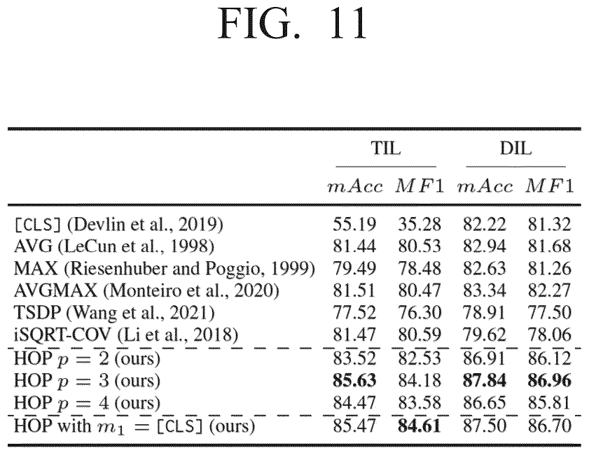

Other pooling schemes and order of HOP. Next, we observe in FIG. 11 how other popular pooling schemes underperform the proposed HOP framework. In “BERT: Pre-training of Deep Bidirectional Transformers for Language Understanding” by Devlin et al, Proceedings of the 2021 Conference of the North American Chapter of the Association for Computational Linguistics: Human Language Technologies (NAACL-HLT), 2018, the [CLS] token is used for the final classification. This is used as the baseline in FIG. 11 and as shown achieves low results because it is unable to cope with the variable distribution of tokens. Another form of pooling—Average pooling (AVG)—is described in “Gradient-based learning applied to document recognition” by LeCun et al published in Proceedings of the IEEE in 1998. FIG. 11 shows that average pooling (AVG) shows remarkable improvements especially in handling the problem variability in the TIL setup. Maximum pooling (MAX) is described in “Hierarchical models of object recognition in cortex” by Riesenhuber et al published in Nature Neural Networks in 1999 and has a slightly worse effect than AVG. Concatenating AVG and MAX (AVGMAX), for example as described in “On the performance of time-pooling strategies for end-to-end spoken language identification” by Monteiro et al published in Conference on Language Resources and Evaluation Conference in 2000 improves the performance compared to using the single clues alone. Employment of only standard deviation (TSDP) or covariance (iSQRT-COV) of tokens improves in TIL, but not on DIL compared to the baseline. TSDP is described in “Revisiting the statistics pooling layer in deep speaker embedding learning” published by Wang et al in IEEE International Conference on Big data in 2021. iSQRT-COV is described in “Towards faster training of global covariance pooling networks by iterative matrix square root normalization” by Li et al published in Conference on Computer Vision and Pattern Recognition in 2018.

Turning to the present method, the high order pooling process using two statistical moments (i.e. p=2, using the first two moments-average and variance) improves results compared to AVGMAX whilst using the same number of statistical measures from the distribution of tokens. We observe that the best results are obtained using three statistical moments (p=3, using the first three moments—average, variance and skewness). Increasing the number of moments to 4 does not improve the performance further. Typically, the CLS token is discarded when using the high order statistics but it is also possible retain the [CLS] token. HOP with m₁=[CLS] shows results similar to our framework, suggesting that the [CLS] token can be used in conjunction with high order statistics with the same results as using AVG. In other words, in HOP m₁ can be either AVG or [CLS].

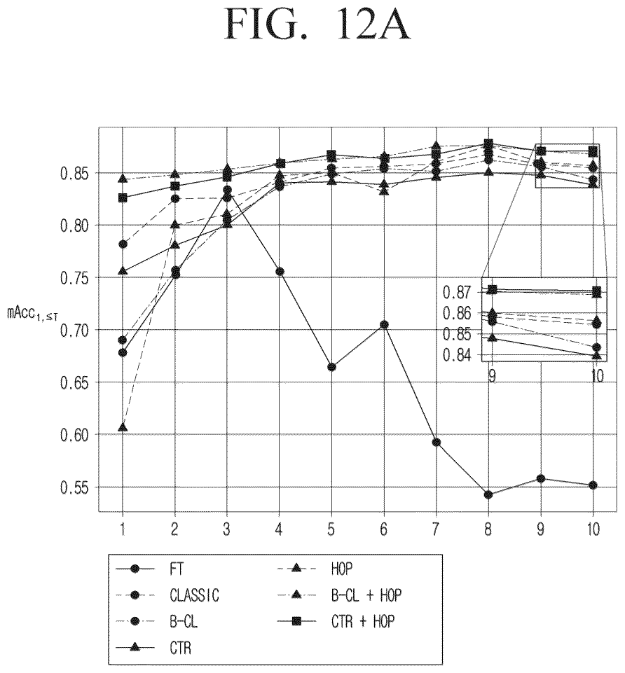

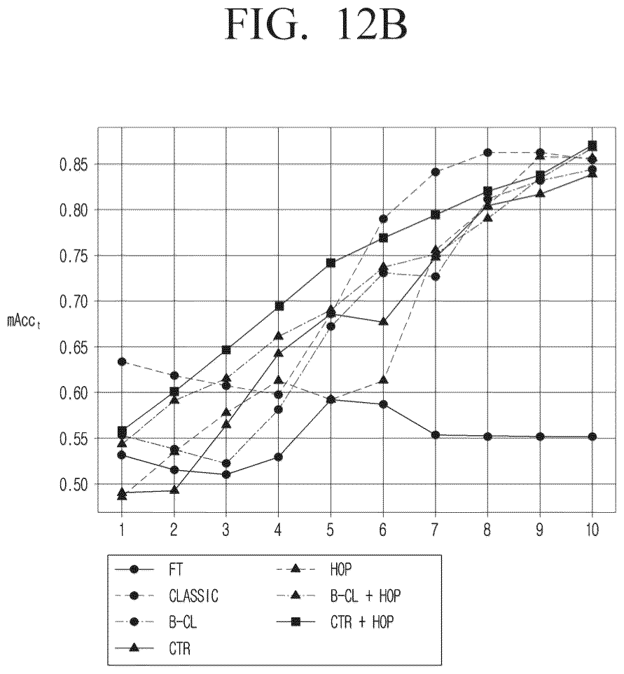

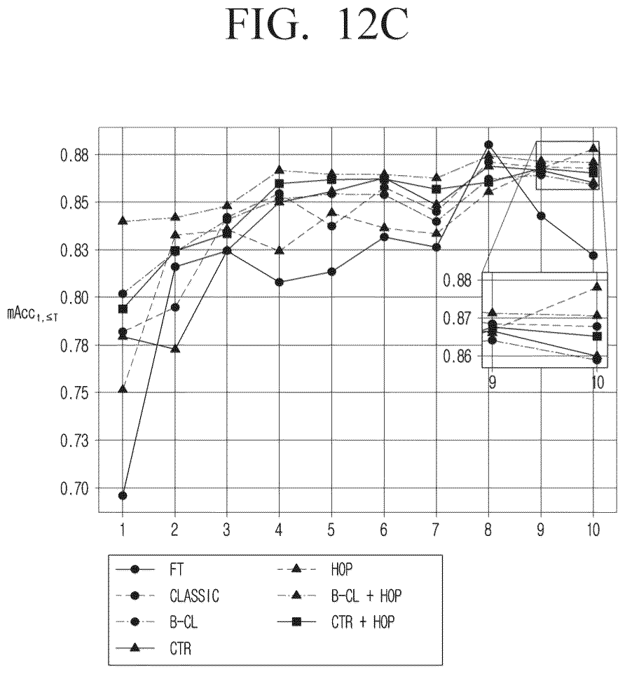

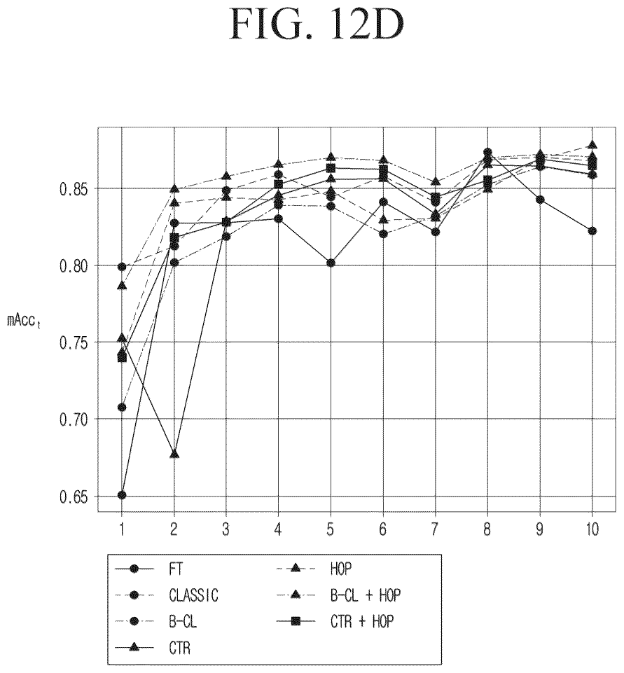

Per-Problem Accuracy. Finally, FIGS. 12a to 12d show the evolution over problem indices of mAccₜ (i.e. per-problem accuracy averaged over all problems) and mAcc_{t≤t} (i.e. per-problem accuracy averaged over the problems seen so far). Fine-tuning FT exhibits a clear performance drop due to catastrophic forgetting and inability to perform knowledge transfer. Methods designed for continual learning in NLP show an almost perfect monotonically increasing behaviour of mAcc_{t≤t}, since they are capable of learning new problems (high plasticity) without forgetting previous ones.

As described above, we proposed a method known as HOP which can be implemented on various architectures, including the one shown in FIG. 1 with adapters and auxiliary MLPs tailored to each task. The HOP steps are, to our knowledge, the first continual learning improvement which is suitable for different CL setups (TIL and DIL) for various target NLP applications (ASC, DSC, NLI, TC). HOP provides high order moment pooling of the embedding tokens to extract rich sentence-wide information rather than relying on a single token (e.g., [CLS]) for classification. Methods extracting just a single token typically fail to adapt to dynamic non-stationary input distributions. HOP effectively encourages knowledge transfer among problems, and protects problem-specific knowledge reducing catastrophic forgetting. The experiments above show that HOP provides improved results on the most widely used CL NLP scenarios. At the same time, HOP only adds minimal computation footprint, making it suitable for mobile CL NLP applications.

The present techniques enable modelling the distribution of embedded tokens via high order statistics, to improve re-use of past knowledge and reduction of forgetting; without storing any replay data and via a computationally efficient framework. The present techniques provide a method to promote parameter-efficient continual learning in NLP via adapters specific to each end problem. The present techniques enable personalization of NLP models to a specific problem via a personal MLP head that processes the enriched information extracted from the distribution of embedded tokens. These techniques can be used alone or in combination.

There are multiple advantages of the present techniques. For example, the present techniques enable personalization, as the final model works best for each specific problem. The present techniques enable storage efficiency via parameter-efficient continual learning since the massive AI model used as backbone is frozen and shared across the learning problems. As noted above, there may be millions or even billions of parameters in the backbone model. Furthermore, there is no need for storing samples belonging to previous problems. The present techniques enable computational efficiency, as unlike recent CL NLP methods, HOP adds only 8.3% increase in computational time. Current state-of-the-art approaches increase training time by 2625% in TIL (CTR) and 158.3% in DIL (CLASSIC). The present techniques enable robustness: robustness and accuracy of our CL model over multiple benchmark datasets (ASC, DSC small, DSC full, 20News, NLI), final NLP applications (ASC, DSC, TC, NLI), CL setups (DIL and TIL) and 3 network architectures based on BERT.

As explained in more detail above, HOP outperforms the best TIL method (CLASSIC) by 17.06% room aware relative (RAR) accuracy gain on DSC full dataset, using Adapter-BERT, while being faster by 2.38× training time. RAR gains are calculated by dividing our baseline with the upper limit baseline. HOP outperforms DIL SOTA (CLASSIC) by 8.02% RAR accuracy gain on DSC small dataset, using Adapter-BERT, while being faster by 2.38× training time. Adding HOP on top of CTR (currently regarded as SOTA in TIL) increases accuracy by 19.45% RAR, while increasing time complexity by 6.17% relative only, in the most challenging scenario with a restricted set of samples (DSC small dataset).

With respect to experiments performed on BERT_frozen+CNN, HOP outperforms TIL SOTA (HAT) by 14.66% RAR accuracy, while being 1.23× faster in training time. HOP outperforms DIL SOTA (UCL) by 14.74% RAR accuracy while having the same training time. With respect to experiments performed on BERT_Adapter, HOP outperforms TIL SOTA (CLASSIC) by 4.65% RAR accuracy, while being 2.38× faster in training time. HOP outperforms DIL SOTA (CLASSIC) by 8.76% RAR accuracy, while being 2.38× faster in training time. Thus, the improvement is robust over benchmark datasets.

There are some use cases of the present techniques. One example use case is personalisation of a large NLP model for a user. This is useful because different people write in very different ways, depending for example on: Instruction Level (e.g., people with no instruction generally have more limited vocabulary and phrase construction abilities); Main language (e.g., people speaking language A have different proverbs than people speaking language B); Job area (e.g., people may is job-related specific words in everyday conversations); Regional area (e.g., different proverbs and way of saying); and Personal taste (e.g., certain people may prefer certain set of words/phrases). Merely as an example of a phrase which has different sentiments. In non-English languages: “break a leg” is associated with a very negative sentiment but in English this is associated with luck and hence a very positive sentiment. In addition to personalizing based on the language being spoken, it is noted that an Englishman speaking in a foreign language may use English idioms in the foreign language and thus needs a model which is personalized to him.

The present techniques enable personalization of any massive AI NLP model. This results in on-device personalization of massive Al models for users. The NLP model could be used for, for example, text classification; Aspect Sentiment Classification; Document Sentiment Classification; Text Classification and Natural Language Understanding.

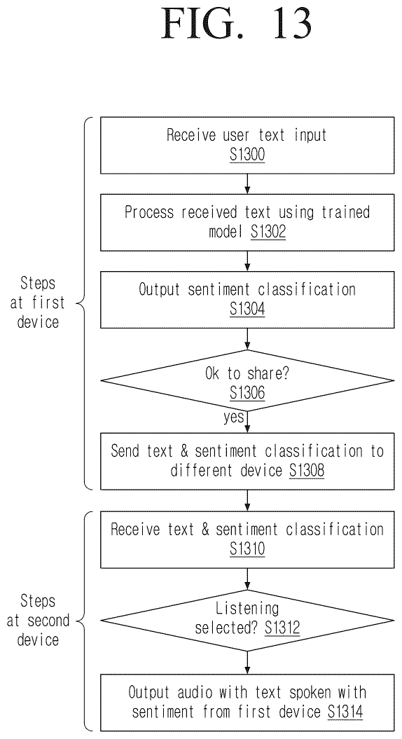

FIG. 13 is an example of a technique in which an aspect sentiment classification (ASC) model has been personalised for a first user of a first device. In a first step S1300, the first user inputs some text into the first device. At step S1302, the input text is processed using the ASC model which has been trained on the first device as described in FIG. 4 and hence is personalised to the first user. The sentiment classification (e.g. happy, sad, angry, etc.) of the input text is output at step S1304. The first device then determines whether data, including the text and/or classification, can be shared with another device at step S1306. For example, the sharing option may be enabled by the first user. At step S1308, when sharing has been enabled, the text and its classification are sent to a second device belonging to a different user.

The remaining steps of FIG. 13 are carried out at the second device. The text and its classification are received at the second device at step S1310. The second device then determines at step S1312 if the second user has selected a listening mode. When the listening option has been selected at step S1314, the second device outputs an audio signal in which the received text is spoken with the sentiment of the first user. This can be done, for example, using the techniques described in “EMOQ-TTS: Emotion Intensity Quantization for Fine-Grained Controllable Emotional Text-to-Speech” by Im et al published in the International Conference on Acoustics, Speech, and Signal Processing (ICASSP) in 2022. By personalising the ASC model on the first device, the user of the second device is able to listen to the text provided by the first user in a way which expresses not just the words, but the words and the sentiment intended. In summary in FIG. 13, a text input is converted to a speech output with the correct sentiment.

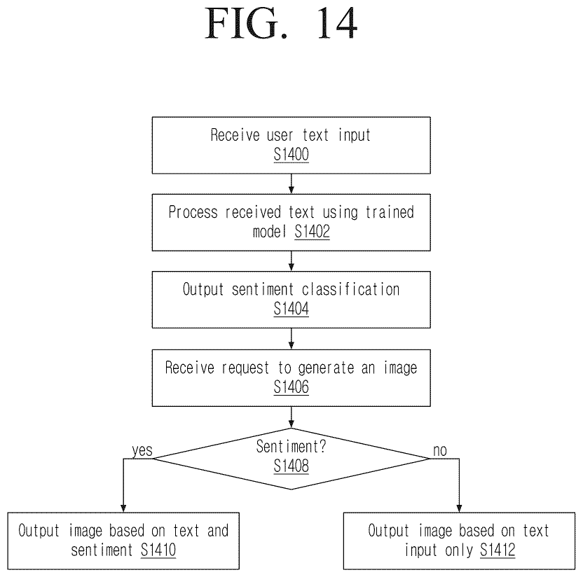

As an alternative to the text to speech conversion shown in FIG. 13, the method of personalising a model can also be used in a text to image conversion as shown in FIG. 14. In a first step S1400, the first user inputs some text into the first device. The text may be a caption. As in FIG. 13, at step S1402, the input text is processed using the ASC model which has been trained on the first device and hence is personalised the first user. The sentiment classification (e.g. happy, sad, angry, etc.) of the input text is output at step S1404. At step S1406, the first device receives a request from the user for an image to be produced based on the input text from the first user.

The first device then determines whether the sentiment analysis is to be considered when producing the image at step S1408. For example, the sentiment option may be enabled by the first user. At step S1410, when the sentiment option has been enabled, the text and its classification are used to produce an appropriate image (i.e. to create or synthesize an image). A different image of a lake will be produced based on the text input “a morning by the lake” for two different classifications of “sad” and “happy”. Merely, as an example, “High-Resolution Image Synthesis with Latent Diffusion Models” by Rombach et al published in CVPR in 2022 may be used to produce the image which synthesises sentiment and text. When the sentiment option is not enabled, an image will also be output at step S1412. However, this image will be based on the text input only and is likely to be different to the output image in step S1410. Any suitable technique may be used to generate the image in this case, for example “Zero-Shot Text-to-Image generation” by Ramesh et al published in the International Conference on Machine Learning (ICML) 2021.

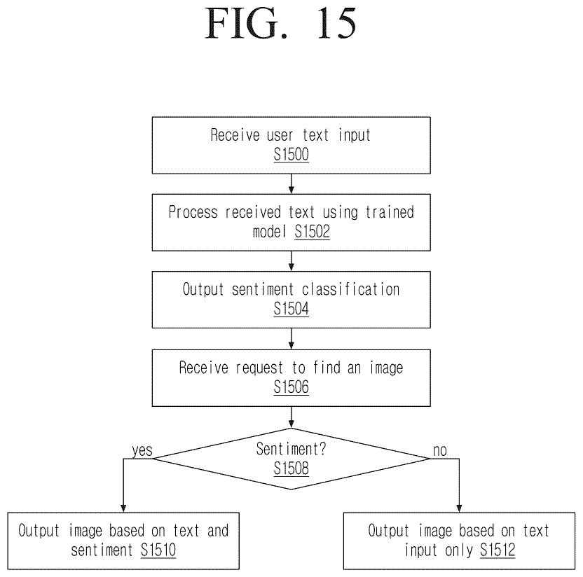

As an alternative to the text to image conversion shown in FIG. 14 in which an image is synthesised, in FIG. 15, text to image conversion may be used to locate an image. The image may be a photo, a GIF, a sticker or any similar image. In a first step S1500, the first user inputs some text into the first device. As in FIG. 14, at step S1502, the input text is processed using the ASC model which has been trained on the first device and hence is personalised the first user. The sentiment classification (e.g. happy, sad, angry, etc.) of the input text is output at step S1504. At step S1506, the first device receives a request to find an image based on the input text.

The first device then determines whether the sentiment analysis is to be considered when finding the image at step S1508. At step S1510, when the sentiment option has been enabled, the text and its classification are used to find an appropriate image. When the sentiment option is not enabled, an image will also be output at step S1512. However, this image will be based on the text input only and is likely to be different to the output image in step S1510.

The present techniques focus on text NLP Al models, but can be applied to any other model and task. For example, traditionally continual learning has focused on image classification. Accordingly the technique could be adapted to image classification. Such approaches can be grouped according to three techniques. A first is regularization-based methods which are generally based on knowledge distillation or on importance score for each parameter to compute a penalty term in the optimization to reduce weight deviation while learning new problems. A second is parameter-isolation approaches which dedicate a set of parameters to each problem to reduce forgetting when learning subsequent problems. Parameters can be either masked out, frozen, or new branches are grown for new problems. A third is replay-based methods which either retain an exemplar set of previously seen data or generated pseudo-samples to reduce CF and promote KT to new problems.

The present techniques also list several applications. Continual learning in NLP is in rapid expansion due to its great importance. Recent works have dealt with catastrophic forgetting in many applications: sentiment analysis, dialogue systems, language modeling and learning, cross-lingual modeling, sentence embedding, machine translation, question answering. The methods described above can also be applied to these uses.

Those skilled in the art will appreciate that while the foregoing has described what is considered to be the best mode and where appropriate other modes of performing present techniques, the present techniques should not be limited to the specific configurations and methods disclosed in this description of the preferred embodiment. Those skilled in the art will recognise that present techniques have a broad range of applications, and that the embodiments may take a wide range of modifications without departing from any inventive concept as defined in the appended claims.

What is claimed is:

1. A method for personalising a machine learning, ML, model, on an electronic user device, the method comprising:
obtaining a pre-trained ML model having a set of basic parameters, wherein the pre-trained ML model has been trained to generate a distribution of embedded representations for an input;
receiving at least one set of user data comprising a plurality of samples, wherein each set is associated with a particular problem;
generating, using the pre-trained model, a distribution of embedded representations for each of the plurality of samples;
generating multiple statistical descriptors for the distribution of embedded representations, and
generating, using the multiple statistical descriptors, an output which is personalised to the user device,
wherein there are fewer statistical descriptors than embedded representations.

2. The method of claim 1, wherein the multiple statistical descriptors include at least two statistical moments selected from average, variance, skewness and kurtosis.

3. The method of claim 2, wherein generating multiple statistical descriptors comprises generating three statistical moments which are average, variance and skewness.

4. The method of claim 2, wherein the multiple statistical descriptors include at least one other statistical measure.

5. The method of claim 1, wherein the pre-trained ML model includes a natural language processing ML model in the form of a tokenizer which generates embedded representations in the form of tokens from a text input.

6. The method of claim 5, further comprising generating a classification token as a first token in the distribution of embedded representations, and
wherein outputting the multiple statistical descriptors includes outputting the classification token.

7. The method of claim 1, further comprising
adding a plurality of adapter modules to the pre-trained ML model to create a local ML model wherein each adapter module has a set of adapter parameters.

8. The method of claim 7, further comprising:
receiving multiple training sets each comprising a plurality of training samples, wherein each training set is associated with a particular problem;
personalising the local ML model using continual learning by selecting a training set;
fixing the set of basic parameters;
using the selected training set to learn a set of adapter parameters for one adapter module in the plurality of adapter modules; and
iterating the selecting, fixing and using for each training set.

9. An electronic user device for personalising a machine learning, ML, model, comprising:
a memory; and
a processor configured to:
obtain a pre-trained ML model having a set of basic parameters, wherein the pre-trained ML model has been trained to generate a distribution of embedded representations for an input,
receive at least one set of user data comprising a plurality of samples, wherein each set is associated with a particular problem,
generate, using the pre-trained model, a distribution of embedded representations for each of the plurality of samples,
generate multiple statistical descriptors for the distribution of embedded representations, and
generate, using the multiple statistical descriptors, an output which is personalised to the electronic user device,
wherein there are fewer statistical descriptors than embedded representations.

10. The electronic user device of claim 9, wherein the multiple statistical descriptors include at least two statistical moments selected from average, variance, skewness and kurtosis.

11. The electronic user device of claim 10, wherein the processor further
generate three statistical moments which are average, variance and skewness for generating the multiple statistical descriptors.

12. The electronic user device of claim 10, wherein the multiple statistical descriptors include at least one other statistical measure.

13. The electronic user device of claim 9, wherein the pre-trained ML model includes a natural language processing ML model in the form of a tokenizer which generates embedded representations in the form of tokens from a text input.

14. The electronic user device of claim 13, wherein the processor further configured to:
generate a classification token as a first token in the distribution of embedded representations, and
wherein outputting the multiple statistical descriptors includes outputting the classification token.

15. The electronic user device of claim 9, wherein the processor further configured to:
add a plurality of adapter modules to the pre-trained ML model to create a local ML model wherein each adapter module has a set of adapter parameters.

16. The electronic user device of claim 15, wherein the processor further configured to:
receive multiple training sets each comprising a plurality of training samples, wherein each training set is associated with a particular problem,
personalize the local ML model using continual learning by selecting a training set,
fix the set of basic parameters,
use the selected training set to learn a set of adapter parameters for one adapter module in the plurality of adapter modules, and
iterate the selecting, fixing and using for each training set.

17. A non-transitory medium that stores one or more instructions executed by a controller of an electronic user device for the electronic user device to perform an operation, the operation comprising:
obtaining a pre-trained ML model having a set of basic parameters, wherein the pre-trained ML model has been trained to generate a distribution of embedded representations for an input;
receiving at least one set of user data comprising a plurality of samples, wherein each set is associated with a particular problem;
generating, using the pre-trained model, a distribution of embedded representations for each of the plurality of samples;
generating multiple statistical descriptors for the distribution of embedded representations, and
generating, using the multiple statistical descriptors, an output which is personalised to the user device,
wherein there are fewer statistical descriptors than embedded representations.

18. The non-transitory medium of claim 17, wherein the multiple statistical descriptors include at least two statistical moments selected from average, variance, skewness and kurtosis.

19. The non-transitory medium of claim 18, wherein generating multiple statistical descriptors comprises generating three statistical moments which are average, variance and skewness.

20. The non-transitory medium of claim 18, wherein the multiple statistical descriptors include at least one other statistical measure.
